(19) United States
(12) Patent Application Publication
(10) Pub. No.: US 2009/0273835 A1
(43) Pub. Date: Nov. 5, 2009

(54) Three-Dimensional Display Apparatus with Diffractive Optical Elements

(76) Inventors: Sheng-Hsiung CHANG, Shihhua Township (TW); Chun-Nan Chen, Tainan City (TW); Heng-Yau Pan, Sinshih Township (TW); Tsair-Chun Liang, Kaohsiung City (TW); Hon Kuan, Tainan City (TW); Tang-Jen Liu, Tainan City (TW)

Correspondence Address: Dr. BANGER SHIA, 102 Lindencrest Ct., Sugar Land, TX, 77479-5201, US

(21) Appl. No.: 12/113,942

(22) Filed: May 1, 2008

(51) Int. Cl. G02B 27/22

(52) U.S. Cl. 359/479

(57) ABSTRACT

A three-dimensional display apparatus includes a case, illuminators, a first mirror, a diffractive optical element and a second mirror. The case can contain an object for display, and includes a movable leaf operable to open and close the case. The illuminators are located around the case for emitting light onto the object. The first mirror is disposed in the case for carrying the weight of the displayed object and reflecting light reflected by the object. The diffractive optical element is located on the case and formed with cells each including portions of regularly changing thicknesses for diffracting the light reflected by the first mirror. The second mirror is located on the diffractive optical element for reflecting the light diffracted by the diffractive optical element, thus forming an image of the displayed object between itself and the diffractive optical element.

### FIELD OF INVENTION

The present invention relates to a display apparatus and, more particularly, to a display apparatus for forming a three-dimensional image of an object and ensuring the security of the object.

### BACKGROUND OF INVENTION

Conventional display apparatuses include glass or acrylic cases for containing objects for display. From the angle of viewers, the display is not adequate. Where the displayed objects are small, the viewers have to bend or squat to have a close look at the displayed objects. Where the viewers are numerous, those in the back cannot have a close look at the displayed objects. Where the displayed objects are precious, the distances between the displayed objects and the viewers must be large to reduce the risk of losing the displayed objects.

Therefore, there is a need for a display apparatus for ensuring the clear display of an object and the security of the object. The present invention is intended to satisfy the need.

### SUMMARY OF INVENTION

It is the primary objective of the present invention to provide a display apparatus for providing a three-dimensional image of an object and ensuring the security of the object.

According to the present invention, the display apparatus includes a case, illuminators, a first mirror, a diffractive optical element and a second mirror. The case can contain an object for display, and includes a movable leaf operable to open and close the case. The illuminators are located around the case for emitting light onto the displayed object. The first mirror is disposed in the case for carrying the weight of the displayed object and reflecting light reflected by the displayed object. The diffractive optical element is located on the case and formed with cells each including portions of regularly changing thicknesses for diffracting the light reflected by the first mirror. The second mirror is located on the diffractive optical element for reflecting the light diffracted by the diffractive optical element, thus forming a three-dimensional image of the displayed object between itself and the diffractive optical element.

Other objectives, advantages and features of the present invention will be apparent from the following description referring to the attached drawings.

### BRIEF DESCRIPTION OF DRAWINGS

The present invention will be described via the detailed illustration of the preferred embodiment referring to the drawings.

FIG. 1 is a perspective view of a three-dimensional display apparatus according to the preferred embodiment of the present invention.

FIG. 2 is a side view of a diffractive optical element used in the three-dimensional display apparatus shown in FIG. 1.

FIG. 3 is a top view of the three-dimensional display apparatus shown in FIG. 1.

FIG. 4 is a table for showing the difference of refractive optical elements, mirrors and diffractive optical elements from one another.

FIG. 5 is a scheme for showing the Fourier transformation of a curved wave front to several rectilinear wave fronts.

FIG. 6 is a scheme for showing the transformation of a wave front to several rectilinear wave fronts with the diffractive optical element shown in FIG. 2.

### DETAILED DESCRIPTION OF PREFERRED EMBODIMENT

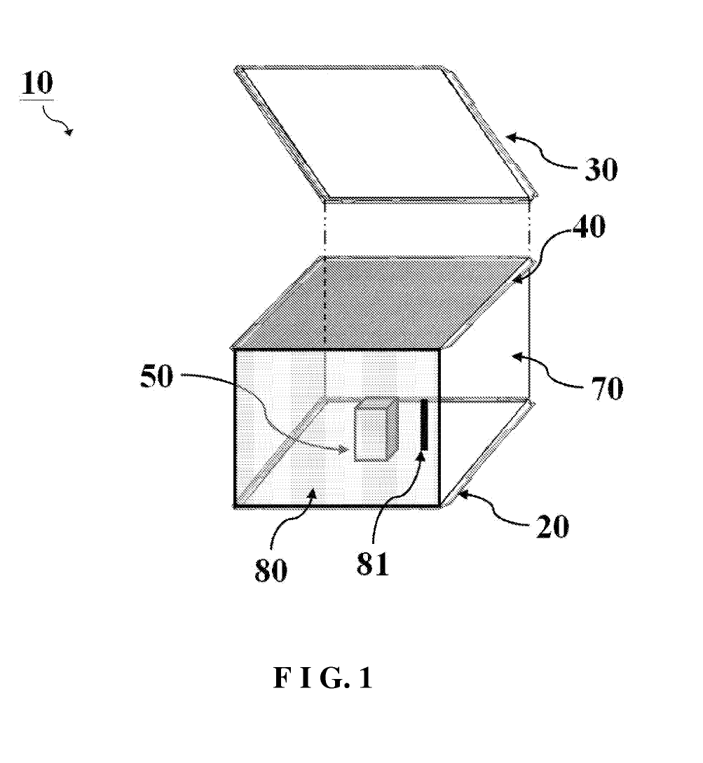

Referring to FIGS. 1 through 3, there is shown a three-dimensional display apparatus 10 according to the preferred embodiment of the present invention. The three-dimensional display apparatus 10 includes a case 70, a first mirror 20, a second mirror 30, a diffractive optical element 40 and three illuminators 61, 62 and 63.

The case 70 is used to contain an object 50 for display. The case 70 includes two lateral panels, a rear panel provided between the lateral panels and a leaf 80 pivotally connected to one of the lateral panels. The leaf 80 is provided with a handle 81 for facilitating the pivoting of the leaf 80 and, therefore, the opening and closing of the case 70.

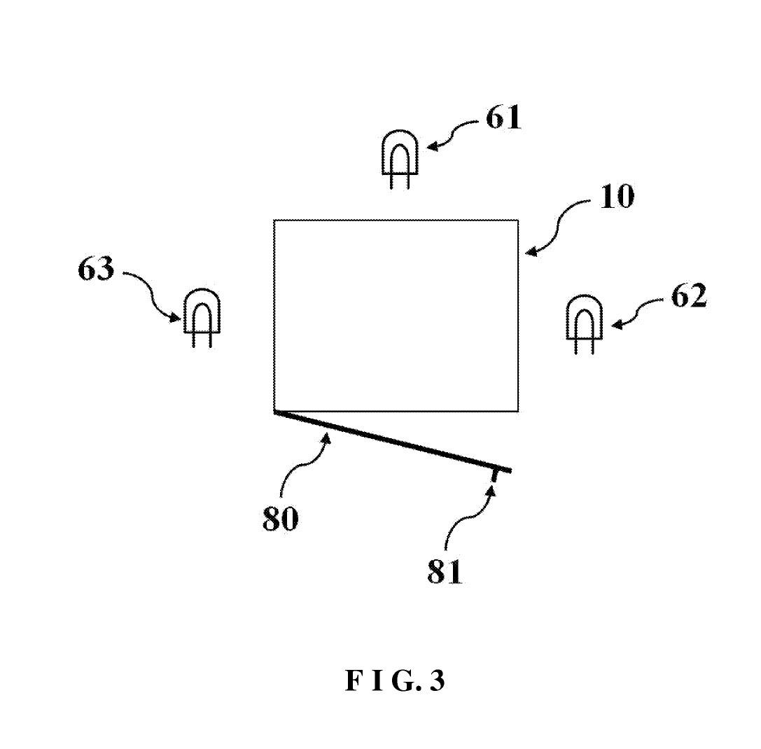

Referring to FIG. 3, the illuminators 61, 62 and 63 are used to cast light onto the object 50. The illuminators 61, 62 and 63 are located on the outside of the case 70. The illuminator 61 is located near the rear panel of the case 70. The illuminator 62 is located near one of the lateral panels of the case 70 while the illuminator 63 is located near the other lateral panel of the case 70.

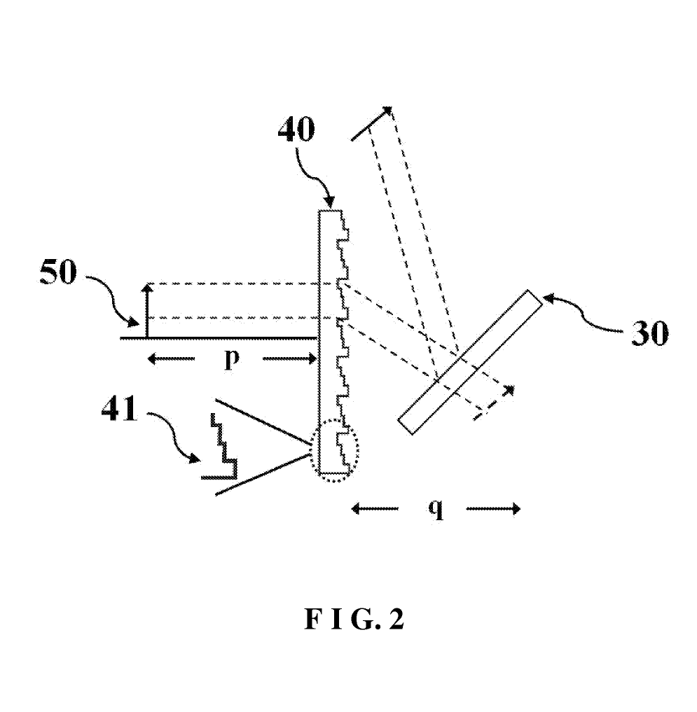

Referring to FIG. 2, the first mirror 20 is used to reflect light reflected by the object 50. The first mirror 20 preferably includes mercury. The reflectance of the first mirror 20 is at least 95%. The first mirror 20 may be used as a lower panel of the case 70 connected to the lateral and rear panels of the case 70. Alternatively, the case 70 may include a lower panel connected to the lateral and rear panels thereof. In this case, the first mirror 20 is simply located on the lower panel of the case 70. In either case, the first mirror 20 is located below the object 50.

The diffractive optical element 40 is used to diffract the light reflected by the first mirror 20. The diffractive optical element 40 may be used as an upper panel of the case 70 connected to the lateral and rear panels of the case 70. Alternatively, the case 70 may include an upper panel connected to the lateral and rear panels thereof. In this case, the diffractive optical element 40 is simply located on the upper panel of the case 70.

Referring to FIG. 2, the diffractive optical element 40 includes a plurality of cells 41. Each of the cells 41 includes a smooth face and a stepped face. That is, each of the cells 41 includes portions of regularly changing thicknesses. Each of the cells 41 includes an even number of portions and, preferably, four portions. The smooth face of each of the cells 41 is closer to the object 50 than the stepped face is. The diffractive optical element 40 is made of glass, indium tin oxide (8ITO8) or photo-resist in a micro-electric mechanic system.

The second mirror 30 preferably includes mercury. The reflectance of the second mirror 30 is at least 95%. The second mirror 30 is located above the diffractive optical element 40. The angle between the second mirror 30 and the diffractive optical element 40 is about 30 to 80 degrees.

In use, the illuminators 61, 62 and 63 cast light onto the object 50. The first mirror 20 reflects light reflected by the object 50. The diffractive optical element 40 diffracts the light reflected by the first mirror 20. The second mirror 30 reflects the light diffracted by the diffractive optical element 40, thus forming a three-dimensional image of the object 50 between itself and the diffractive optical element 40.

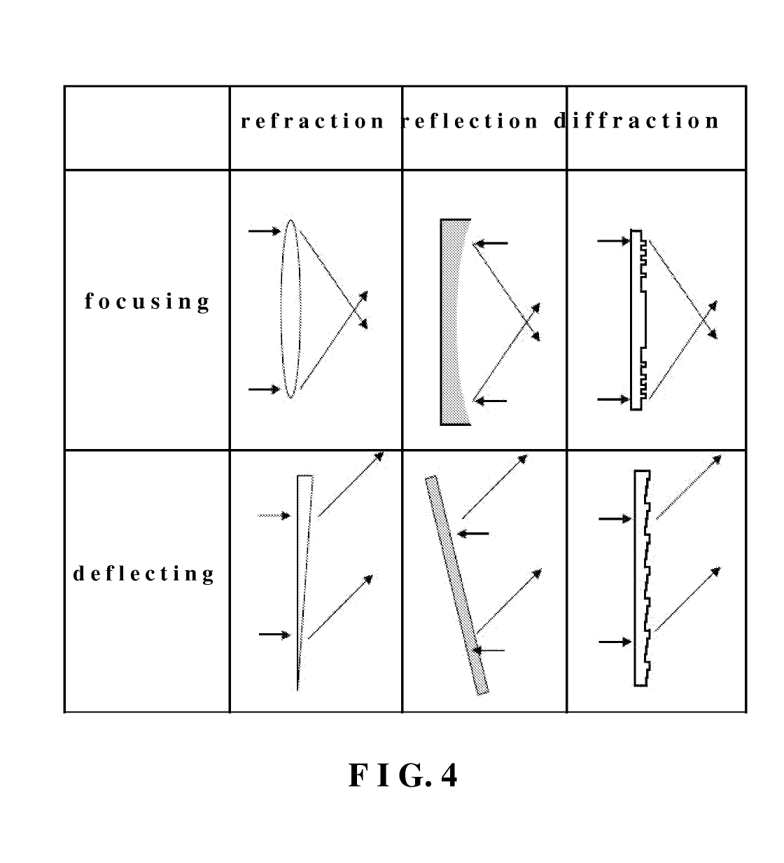

Referring to FIG. 4, there will be discussed principles on which the diffractive optical element 40 works. For a refractive optical element, diffraction only occurs in the presence of a miniature aperture. That is, diffraction does not provide modulation for a lens. The refractive optical element is subject to diffraction limit. The refraction limit is particularly obvious with a micro-lens array.

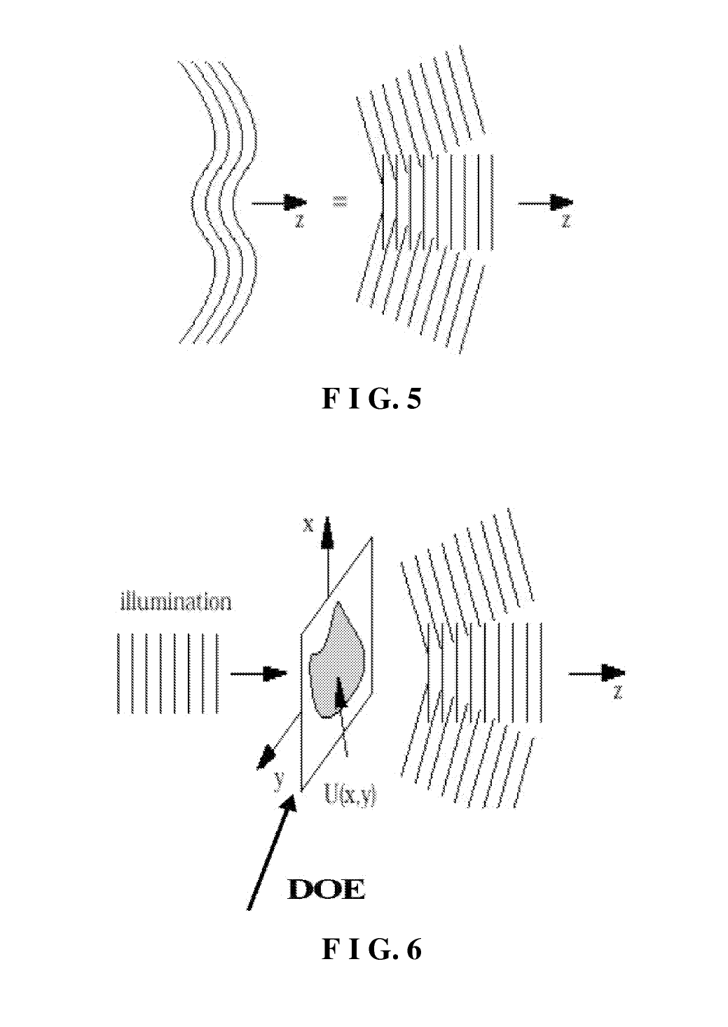

Referring to FIG. 5, a curved wave front can be transformed to several rectilinear wave fronts of different intensity according to the Fourier transformation.

Referring to FIG. 6, a rectilinear wave front is transformed to several rectilinear wave fronts of different intensity with the diffractive optical element 40. The directions of the travel of the wave fronts will be changed if the stepped side of each of the cells 41 of the diffractive optical element 40 is changed. The speed of a wave front is influenced by the index of refraction and thickness of a diffractive optical element effect. Hence, the stepped side of each of the cells 41 can be designed to determine the directions of the travel of the wave fronts, thus forming an image of the object 50 within the second mirror 30.

During the design of the diffractive optical element 40, there is calculated an interference pattern of certain wave fronts, i.e., a computer-generated hologram. Then, a digital plotter is used to plot the interference pattern. The interference pattern is reduced and developed on a microfilm. The profile of each of the cells 41 of the diffractive optical element 40 is designed to modulate the phase of the optical field on the incidence side and control the phase of the optical field on the emergence side, thus determining the distribution of the energy of the emerging light.

There are four methods for designing the diffractive optical element 40, i.e., the optical path method, the scalar diffraction theory, the rigorous coupled wave theory and the effective medium theory. Preferably, the diffractive optical element 40 is designed based on the scalar diffraction theory. According to the scalar diffraction theory, the diffraction of light is explained based on the wave motion of light. This is sometimes called the 8Fourier optics.8 Each point on a wave front is deemed a secondary source of spherical waves. That is, the wave packets of the secondary sources together form a new wave front. The wavelength of the incident light, the wavelength of the emerging light and the index of refraction of the diffractive optical element 40 are used to determine the direction of the emerging light. The efficiency of diffraction is related to the number of the cells 41 of the diffractive optical element 40.

As discussed above, each of the cells 41 includes an even number of portions of regularly changing thicknesses and, preferably, four portions. Each of the cells 41 is 16 micrometers long. The thickness of each of the portions of each of the cells 41 determines the direction of diffraction of the wave front of the incident light. The cells 41 are used to spread rays of light at different angles, thus evenly distributing the energy. The cells 41 are not thicker than 10 micrometers. The angle of diffraction of the cells 41 is not larger than 90 degrees.

Regarding the forming of an image, not like any conventional lens, the diffractive optical element 40 does not require a specific relation of the distance from the object 50, the focus and the distance from an image with one another. As long as the diffractive optical element 40 is about the size of the object 50, an image of the object 50 can be formed. If a mirror is located before the position of the image of the object 50, the image of the object 50 can be cast into the air for viewers to see.

Referring to FIG. 2, the making of the diffractive optical element 40 will be described. There are three methods for making the diffractive optical element 40, i.e., a hologram method, a lithography process and a direct recording method. Preferably, the diffractive optical element 40 is made in the lithography process. A substrate made of quartz, glass, ITO or photo-resist is processed in the lithography process. To make the cells 41, the lithography process and an etching process are used.

Alternatively, a grayscale mask may be used. The grayscale mask causes different hues that cause different depths of exposure into the photo-resist. Therefore, the portions of different thicknesses of each of the cells 41 are made. The photo-resist may be selected from, but not limited to, the AZ positive photo-resist series and the SU-8 negative photo-resist series.

Taking the rapid development of micro-electric mechanic systems and a need to minimize devices, the cells 41 can be made in a LIGA process. That is, a mold of the cells 41 is made on a substrate of silicon in a semi-conductor process. The mold is coated with a transparent layer of polysiloxane or the like. After baking, the transparent layer is removed from the mold and used as the diffractive optical element 40 about 5 micrometers thick.

As discussed above, the three-dimensional display apparatus 10 uses the diffractive optical element 40 to perfectly form the three-dimensional image of the object 50 before the viewers. The display of the object 50 is clear. The security of the object 50 is ensured.

The present invention has been described via the detailed illustration of the preferred embodiment. Those skilled in the art can derive variations from the preferred embodiment without departing from the scope of the present invention. Therefore, the preferred embodiment shall not limit the scope of the present invention defined in the claims.

1. A three-dimensional display apparatus comprising:
a case for containing an object for display, the case comprising a movable leaf operable to open and close the case;
illuminators located around the case for emitting light onto the displayed object;
a first mirror disposed in the case for carrying the weight of the displayed object and reflecting light reflected by the displayed object;
a diffractive optical element located on the case and formed with cells each comprising portions of regularly changing thicknesses for diffracting the light reflected by the first mirror; and
a second mirror located on the diffractive optical element for reflecting the light diffracted by the diffractive optical element, thus forming an image of the displayed object between itself and the diffractive optical element.

2. The three-dimensional display apparatus according to claim 1, wherein the diffractive optical element comprises a substrate made of a material selected from a group consisting of glass, indium tin oxide and transparent photo-resist.

3. The three-dimensional display apparatus according to claim 1, wherein the diffractive optical element is made in a micro-electric mechanic system.

4. The three-dimensional display apparatus according to claim 1, wherein the amount of the portions of each of the cells is an even number.

5. The three-dimensional display apparatus according to claim 4, wherein the amount of the portions of each of the cells is four.

6. The three-dimensional display apparatus according to claim 4, wherein the length of each of the cells is 16 micrometers.

7. The three-dimensional display apparatus according to claim 1, wherein the thickness and reflectance of the cells determine the direction of diffraction of the wave front of light.

8. The three-dimensional display apparatus according to claim 1, wherein the thickness of the cells is not larger than 10 micrometers.

9. The three-dimensional display apparatus according to claim 1, wherein the angle of diffraction of the cells is not larger than 90 degrees.

10. The three-dimensional display apparatus according to claim 1, wherein the second mirror is at 30 to 80 degrees from the diffractive optical element.

11. The three-dimensional display apparatus according to claim 1, wherein the leaf comprises a handle formed thereon to facilitate the operation of the leaf.

12. The three-dimensional display apparatus according to claim 1, wherein the first mirror comprises mercury and the reflectance thereof is not lower than 90%.

13. The three-dimensional display apparatus according to claim 1, wherein the second mirror comprises mercury and the reflectance thereof is not lower than 90%.
